(19) United States
(12) Patent Application Publication
(10) Pub. No.: US 2004/0239130 A1
(43) Pub. Date: Dec. 2, 2004

(54) Household and gardening device

(76) Inventors: Andreas Heuel, Freudenberg (DE); Peter Finkler, Namborn (DE)

Correspondence Address: OSTROLENK FABER GERB & SOFFEN, 1180 AVENUE OF THE AMERICAS, NEW YORK, NY, 100368403

(21) Appl. No.: 10/487,682

(22) PCT Filed: Aug. 22, 2002
(86) PCT No.: PCT/EP02/09409

(30) Foreign Application Priority Data
Aug. 24, 2001 (DE) 201 14 006.3

(51) Int. Cl. A01B 1/22

(52) U.S. Cl. 294/57

(57) ABSTRACT

A domestic and garden implement having a part on the implement side of a handle fastening coupling, with which the implement, can be fixed to an implement handle. The part of the implement side of the handle fastening coupling has an implement insertion pin, which can be plugged into the end of the handle and can be fixed there via coupling elements on the handle side. A stop socket is pushed onto the implement insertion pin. The socket has a top part and a cuff, which are formed in the manner of a sleeve and can be pushed into each other and locked. The cuff has projecting lugs into the top part. The lugs have holes running perpendicular to the axis of the handle, which align with holes in the top part. The implement insertion pin has a further hole, which can overlap these. A locking pin fixes the socket by engaging through all the holes. The locking pin is part of a cover at the top part. The end on the handle side of the cuff is provided with a collar which encloses the end of the handle in the coupled state. This end is provided with a plurality of symmetrically arranged knobs in order to compensate for axial tolerances.

The invention relates to domestic and garden implements which, as hand-held implements, can be fixed to an implement handle and, in particular, the invention relates to the coupling part on the implement side of a handle fastening coupling, as described in EP-0 057 916, for example. This handle fastening coupling has an implement insertion hole in the handle, which penetrates the end on the implement side of the handle axially and into which an implement insertion pin can be inserted, being matched to the cross section of the implement insertion hole for the purpose of being held with a form fit. The implement insertion pin has a locking recess, in which a coupling element of the implement handle engages with a form fit. Said element can be formed as a coupling spring, for example. The implement insertion pin bears a stop socket, against which the end of the coupled handle rests.

In known handle fastening couplings, the stop socket is assembled from two half shells divided in the axial plane, which can be latched onto the implement insertion pin. The implement insertion pin is preferably formed as a flat bar.

The invention is based on the object of improving the part on the implement side of the handle fastening coupling in such a way that a play-free connection between implement and handle is still ensured even after a relatively long period of use.

The set object is achieved by all of the features specified in claim 1 and claim 2.

The fact that the radially divided socket can be placed without play with its through-hole on the implement insertion pin prevents the socket tilting. The locking pin achieves the situation where the socket is fixed on the implement insertion pin without play in the axial direction. Any production tolerances which may occur can be compensated for by the knobs on the end of the socket.

Refinements of the invention emerge from the subclaims.

An exemplary embodiment of the invention will be described below using the drawing, in which:

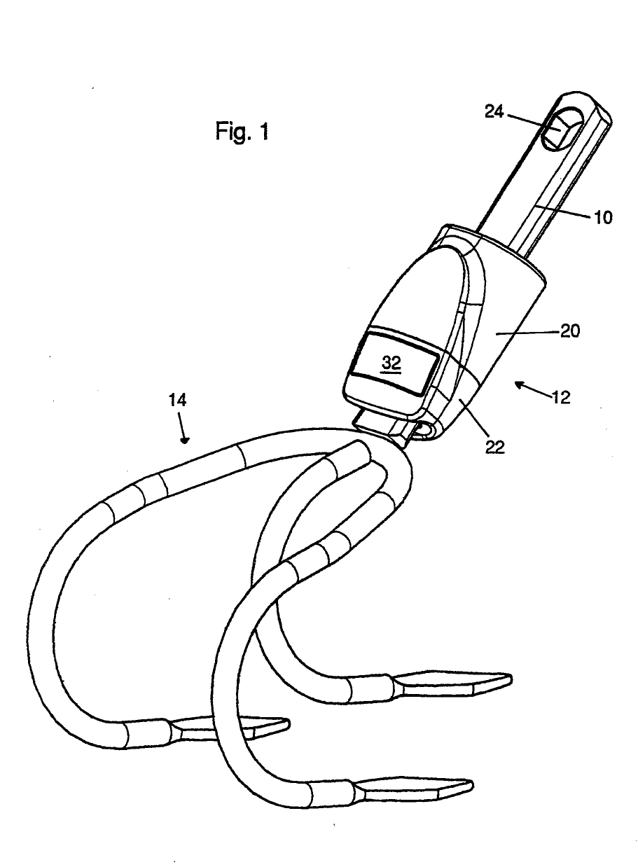

FIG. 1 is a perspective illustration of a tool formed as a grubber with the part on the tool side of a completely mounted handle fastening coupling, whose mating piece is arranged on a handle, not illustrated in the drawing;

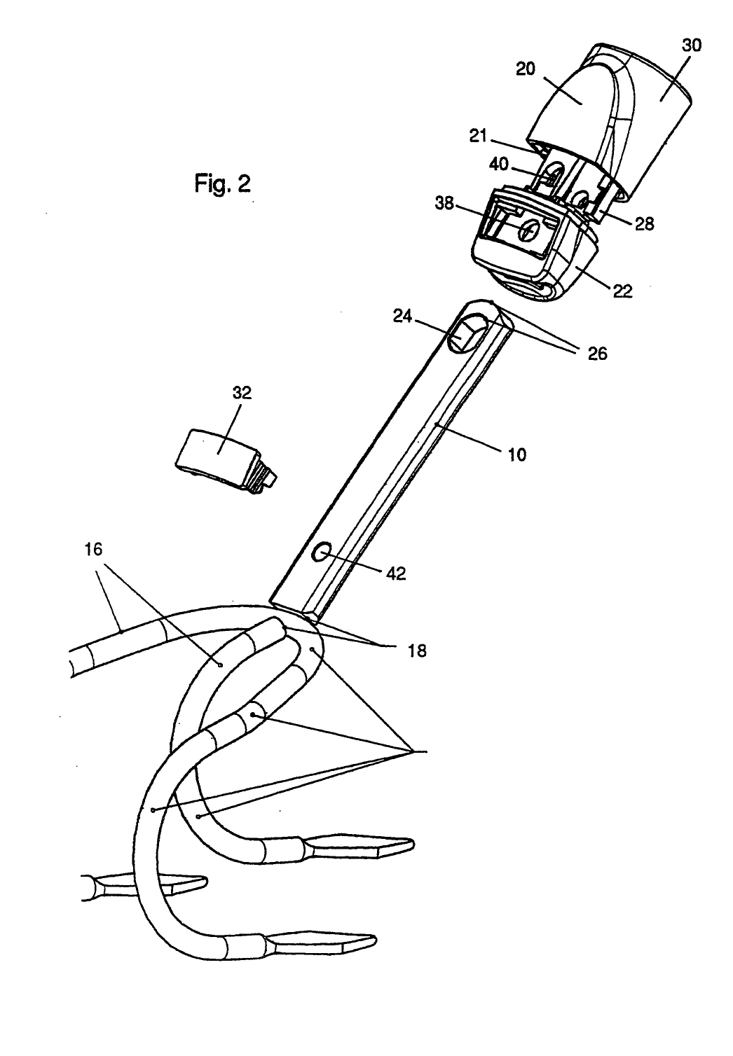

FIG. 2 is a perspective illustration of the tool with handle fastening coupling, whose individual parts are illustrated in an exploded manner for clarity;

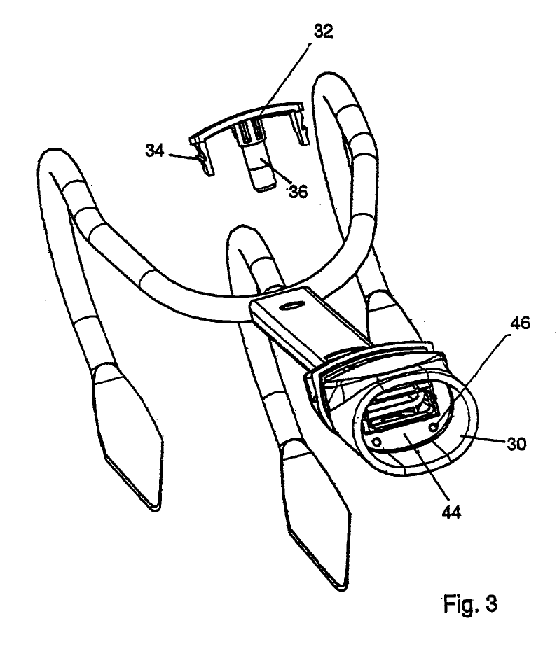

FIG. 3 is a perspective illustration of the tool with the three as yet separated parts of the handle fastening coupling.

In the drawing, only the part on the implement side of a handle fastening coupling is illustrated, whose mating piece is arranged in a handle, not illustrated, which can be coupled to different tools or implements. This part on the implement side of the handle fastening coupling has an implement insertion pin 10 which, according to the preferred exemplary embodiment, is formed as a flat bar and which can be inserted into an implement insertion hole at the end on the implement side of the handle. As an insertion limit for the end of the handle, a socket 12 is fixed to the implement insertion pin 10, the handle coming to rest against the end of said socket on the handle side. Fixed to the rear end of the implement insertion pin 10 is a tool 14 which, according to the exemplary embodiment illustrated, is formed as a grubber which has three tines 16. Instead of the grubber, other garden implements such as rakes, curved cultivators, straight hoes, drag hoes, curved hoes, daisy grubbers, spring-tine rakes and many other implements can be connected to the implement insertion pin. According to the exemplary embodiment illustrated, the connection to the implement pin 10 is made via welds 18.

The socket 12 comprises two sleeve-like parts, namely a cuff 20 and a top part 22, both of which are fitted with through holes whose cross-sectional shape corresponds exactly to the cross-sectional shape of the implement insertion pin 10, so that the two parts can be pushed without play onto the implement insertion pin 10.

At its end on the handle side, the implement insertion pin 10 has a locking recess 24, in which a coupling element of the coupling part on the handle side can engage with a form fit when the implement insertion pin 10 is pushed into the implement insertion hole at the end of the handle. The end of the implement insertion pin has rounded control surfaces, the radii 26 of the control surface and the end of the hole on the handle side being identical.

As can be seen in particular from FIG. 2, the cuff 20 has two fork-like lugs 21, which come to lie on either side of the pin insertion hole and can be pushed into corresponding recesses in the top part 22. Latching means 28 in the shape of spring tongues with locking catches hold the cuff 20 and top part 22 together when they are plugged together. The cuff 20 is provided with a collar 30 which, in the coupled state, encloses the end of the handle. The top part 22 is provided with a recess into which a cover 32 fits, which can be fixed into the cuff via latching hooks 34.

In the region of this recess for the cover 32, the top part 22 has a hole 38 which, in the plugged-together state, aligns with holes 40 in the lugs 21 of the cuff 20. The socket preassembled in this way is pushed onto the implement insertion pin 10 until the holes 38, 40 align with a locking hole 42 in the implement insertion pin 20. The cover 32 is then inserted, which has a locking pin 36 which is pushed through the holes 38, 40 and 42 and, as a result, fixes the socket 12 without play on the implement insertion pin 10.

On the front end 44 of the cuff 20, which is located inside the collar 30 and comes to rest against the front end of the handle, four knobs 36 are arranged in order to compensate for axial tolerances, can be deformed to a limited extent and, as a result, fix the implement to the handle without play.

### List of Designations

10 Implement insertion pin

12 Socket

14 Tool (grubber)

16 Tines

18 Weld

20 Cuff

21 Lugs

22 Top part

24 Locking recess

26 Radii

28 Latching means

30 Collar

32 Cover

34 Latching hook

36 Locking pin

38 Hole in 22

40 Hole in 20

42 Locking hole

44 End face

46 Knobs

1. A domestic and garden implement having an implement side; a coupling part on the implement side, the coupling part having an implement insertion pin for carrying a tool
a stop socket to be placed onto the end of the handle
the socket comprising two sleeve-like socket parts, including a top part and a cuff which are latched to each other
one socket part has projecting lugs which project into the other socket part
each socket part has a respective plug-in pin hole, for placing the parts without play on the implement insertion pin;
locking holes in the implement insertion pin; both socket parts have congruent holes when the socket parts are together and the congruent holes can be aligned with the locking holes in the implement insertion pin;
a locking pin which is pushed into the aligned holes, which include the locking holes and the congruent holes for locking the socket on the insertion pin.

2. A domestic and garden implement having an implement side; a coupling part on the implement side, the coupling part having an implement insertion pin for carrying a tool;
a stop socket to be placed onto the end of the handle,
the stop socket having an end face on the implement side of the socket with a plurality of axially oriented knobs (46) to compensate for axial tolerances.

3. The domestic and garden implement as claimed in claim 1, further comprising a cover to which the locking pin is fixed, the cover having a plugged-in state, and the cover being shaped to align with an outer surface of the top part; and latching hooks for latching the cover to the top part.

4. The domestic and garden implement as claimed in claim 1, wherein the sleeve-like cuff includes two lugs which rest on the implement insertion pin, the lugs have through holes which, in the plugged-in state of the top part, comprise the congruent holes that align with the locking hole.

5. The domestic and garden implement as claimed in claim 1, wherein the cuff has a handle side with an end which is provided with a collar enclosing the end of the handle.

6. The domestic and garden implement as claimed in claim 4, wherein the cuff has a handle side with an end which is provided with a collar enclosing the end of the handle.
